(19) United States
(12) Patent Application Publication
(10) Pub. No.: US 2025/0061238 A1
(43) Pub. Date: Feb. 20, 2025

(54) TECHNOLOGIES FOR MANAGING SMART CONTRACTS

(71) Applicant: The PNC Financial Services Group, Inc., Pittsburgh, PA (US)

(72) Inventors: Michael Minella, Pittsburgh, PA (US); Connor Thompson, Pittsburgh, PA (US); Caylan Sankitts, Pittsburgh, PA (US)

(21) Appl. No.: 18/805,688

(22) Filed: Aug. 15, 2024

Related U.S. Application Data
(60) Provisional application No. 63/519,940, filed on Aug. 16, 2023.

(51) Int. Cl. G06F 21/64

(52) U.S. Cl. CPC G06F 21/64

(57) ABSTRACT

Technologies for managing smart contracts include a compute device. The compute device includes circuitry configured to obtain a smart contract indicative of a condition and a responsive action to be performed upon satisfaction of the condition. The circuitry is also configured to write the smart contract to a centrally managed immutable database, obtain, from an event stream, data indicative of an event published to the event stream, determine, as a function of the event published to the event stream and the smart contract, whether the condition has been satisfied, and perform, in response to a determination that the condition has been satisfied, the responsive action.

### CROSS-REFERENCE TO RELATED APPLICATION

This application claims the benefit, under 35 U.S.C. § 119(e), of U.S. Provisional Patent Application No. 63/519,940, filed Aug. 16, 2023, the entirety of which is hereby expressly incorporated by reference herein.

### BACKGROUND

Typical computer systems used in managing operations of an organization or relationships between parties execute a series of defined rules that are hard coded by a software developer. As such, for users of the systems, new rule sets for different scenarios cannot be readily added and changes to existing rules cannot be easily made. Rather, resources must be expended on software development effort to implement new rule sets in an executable format understood by the computer systems.

Aside from the challenges in implementing changes in the logic or rule sets used in typical systems, the data sets associated with typical systems may also be problematic. For example, incoming data utilized by such systems is typically limited to a fixed source. Further, record events pertaining to a scenario managed by a typical computer system may be in a data structure that is vulnerable to retroactive modification, thereby undermining the veracity of the data. As such, typical systems may suffer from inflexibility in their logic and ability to handle new situations and the data sets utilized and/or produced by such systems are subject to technical limitations (e.g., lower integrity, incompatibility with other data sources, etc.) that may reduce their effectiveness in managing arrangements among parties.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for managing smart contracts;

FIG. 2 is a simplified block diagram of at least one embodiment of a compute device of the system of FIG. 1;

FIGS. 3-6 are simplified block diagrams of at least one embodiment of a method for managing smart contracts that may be performed by the system of FIG. 1;

FIG. 7 is a diagram of a relationship between an event stream, a smart contract service, an immutable database, and one or more communicatively-connected compute devices that may be established by the system of FIG. 1;

FIG. 8 is a diagram of a structure of a centrally managed blockchain that may be utilized by at least one embodiment of the system of FIG. 1; and

FIGS. 9-11 are diagrams of user interfaces that may be provided by the system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

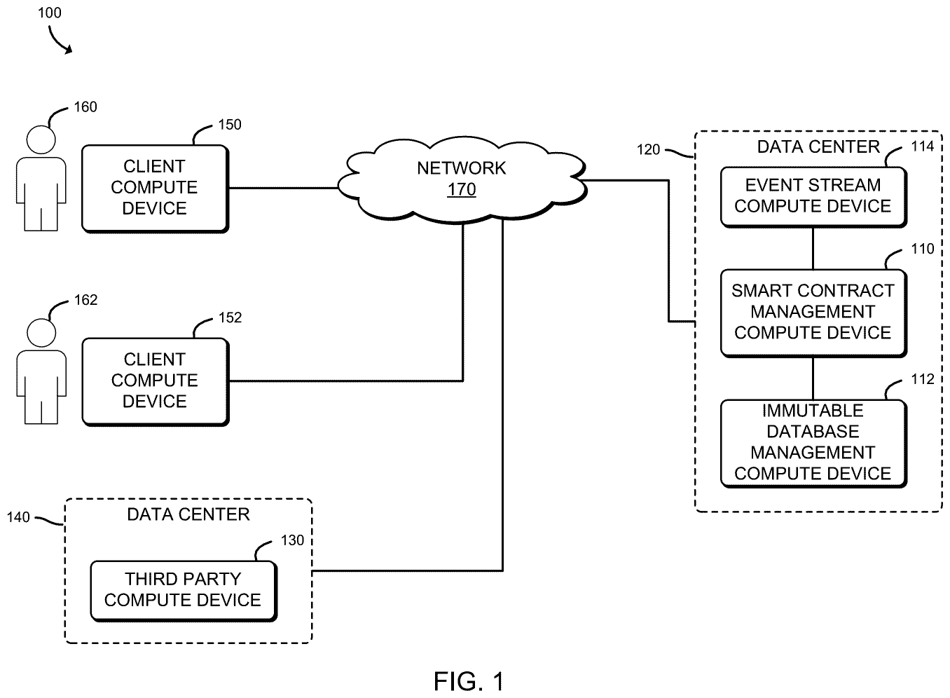

Referring now to FIG. 1, a system 100 for managing smart contracts (e.g., computer-executed logic representing an agreement, defining one or more conditions to be met and one or more responsive actions to be triggered upon satisfaction of the condition(s)) includes, in the illustrative embodiment, a smart contract management compute device 110 communicatively connected to an immutable database management compute device 112 and an event stream compute device 114. The immutable database management compute device 112 may be embodied as any device (e.g., a server compute device) configured to write to and read from an immutable database, such as a blockchain, upon request (e.g., from the smart contract management compute device 110). In the illustrative embodiment, the event stream compute device 114 may be any device (e.g., a server compute device) configured to aggregate data indicative of incidents, changes in states of data objects, or other events from a multitude of sources (e.g., mainframes, servers, and/or other compute devices operating as authoritative data sources or “systems of record” for corresponding types of information) in a normalized format. The event stream compute device 114 organizes the events into a real time or near real time stream (an “event stream”) that other compute devices can selectively subscribe to (e.g., receive data from) based on topics (e.g., key words, tags, etc.).

The compute devices 110, 112, 114 are, in the illustrative embodiment, located in a data center 120. Additionally, the system 100 illustratively includes a third party compute device 130 in a corresponding data center 140. The third party compute device 130 may be a computer operated by a business organization other than an organization operating the compute devices 110, 112, 114. For example, the compute devices 110, 112, 114 may be operated by a financial institution, such as a bank, and the third party compute device 130 may be operated by a retailer or other entity that may interact with one or more of the compute devices 110, 112, 114 through an application programming interface (API) via a network 170. Further, in the illustrative embodiment, the system 100 includes multiple client compute devices 150, 152 operated by corresponding users 160, 162. In some embodiments, the users 160, 162 may be members of an organization, such as a decentralized autonomous organization (DAO) (e.g., an organization without centralized leadership and whose rules are encoded as sets of computer-executable instructions). The client compute devices 150, 152 may interact with one or more of the compute devices 110, 112, 114 via the network 170. While a single third party compute device 130 and two client compute devices 150, 152 are shown for clarity, it should be understood that the number of third party compute devices, client compute devices, and corresponding users may be different and may range in the tens, hundreds, thousands, or more. Likewise, it should be understood that the compute devices 110, 112, 114 may be housed in multiple data centers rather than a single data center (e.g., the data center 120). Further, though shown as separate compute devices 110, 112, 114, in some embodiments, the functionality of one or more of the compute devices 110, 112, 114 may be combined into a single compute device and/or distributed across more than three physical compute devices.

In operation, and as described in more detail herein, the system 100 and in particular, the smart contract management compute device 110 in coordination with the immutable database management compute device 112 and the event stream compute device 114, obtains data indicative of a smart contract, writes the smart contract to an immutable database (e.g., a blockchain) that is centrally managed (e.g., only providing write access to the entity operating the compute devices 110, 112, 114), monitors an event stream (e.g., a real-time or near-real time record of events published by one or more connected systems and associated with key terms (referred to herein as topics)), and performs ongoing management of the smart contract in accordance with the events. The ongoing management includes determining whether events from the event stream indicate satisfaction of the condition(s) in the smart contract and performing responsive action(s) associated with the smart contract.

Unlike typical systems, the system 100 provides for self-execution of the terms of a contract without reliance on a human to determine whether the condition(s) of an agreement have been met and manually perform any responsive actions. Additionally, the system 100 provides an immutable record of the circumstances that led to the satisfaction of the condition(s) and enables interoperability with a variety of data sources (e.g., through the event stream) to capture data regarding the occurrences of events pertaining to a given smart contract. Further, the system 100 enables the logic associated with a smart contract to be readily modified (e.g., upon approval by a threshold number of votes from parties with voting rights). Accordingly, these features enable the system 100 to provide a far more robust and adaptable platform for managing agreements among parties, including the agreements among members within an organization (e.g., a decentralized autonomous organization (DAO)), compared to conventional systems that do not provide the above features.

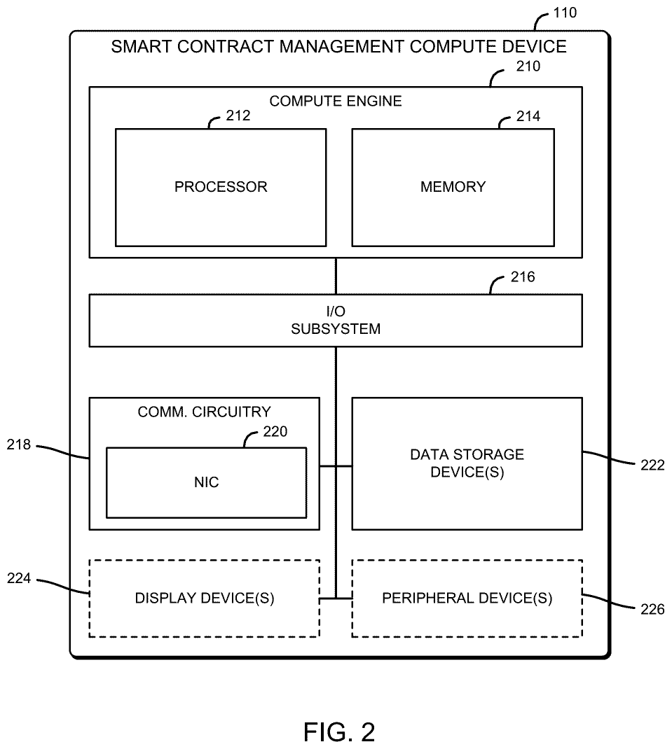

Referring now to FIG. 2, the illustrative smart contract management compute device 110 includes a compute engine 210, an input/output (I/O) subsystem 216, communication circuitry 218, and one or more data storage devices 222. In some embodiments, the smart contract management compute device 110 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the smart contract management compute device 110 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding that a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as data indicative of smart contracts, event stream topics subscribed to for each smart contract, conditions of each smart contract, responsive actions for each smart contract, parties to each smart contract, data read from an immutable database, data written to an immutable database, blockchain hashes, applications, libraries, and drivers.

The compute engine 210 is communicatively coupled to other components of the smart contract management compute device 110 via the I/O subsystem 216, which may be embodied as circuitry and/or components to facilitate input/output operations with the compute engine 210 (e.g., with the processor 212 and the main memory 214) and other components of the smart contract management compute device 110. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the smart contract management compute device 110, into the compute engine 210.

The communication circuitry 218 may be embodied as any communication circuit, device, or collection thereof, capable of enabling communications over a network between the smart contract management compute device 110 and another device (e.g., a compute device 112, 114, 130, 150, 152, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the smart contract management compute device 110 to connect with another compute device (e.g., the event stream compute device 114, the immutable database management compute device 112, a third party compute device 130, a client compute device 150, 152, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the smart contract management compute device 110 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the smart contract management compute device 110 are housed in a single unit. However, in other embodiments, the components may be in separate housings, in separate racks of a data center, and/or spread across multiple data centers or other facilities. The immutable database management compute device 112, the event stream compute device 114, the third party compute device 130, and the client compute devices 150, 152 may have components similar to those described in FIG. 2 with reference to the smart contract management compute device 110. The description of those components of the smart contract management compute device 110 is equally applicable to the description of components of the compute devices 112, 114, 130, 150, 152. Further, it should be appreciated that any of the devices 112, 114, 130, 150, 152 may include other components, sub-components, and devices commonly found in a computing device, which are not discussed above in reference to the smart contract management compute device 110 and not discussed herein for clarity of the description.

In the illustrative embodiment, the compute devices 110, 112, 114, 130, 150, 152 are in communication via a network 170, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

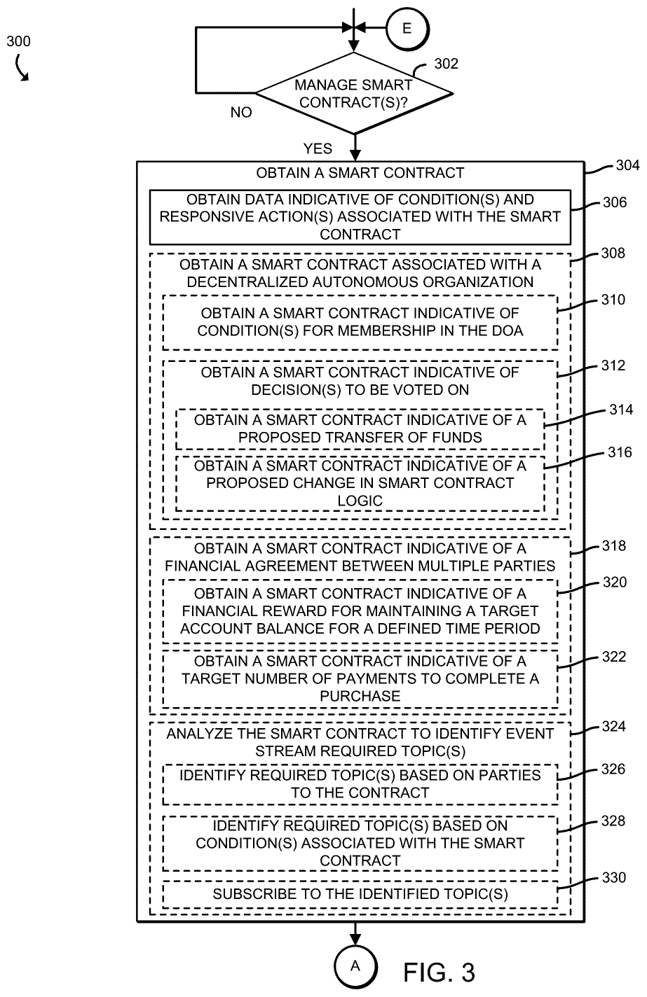

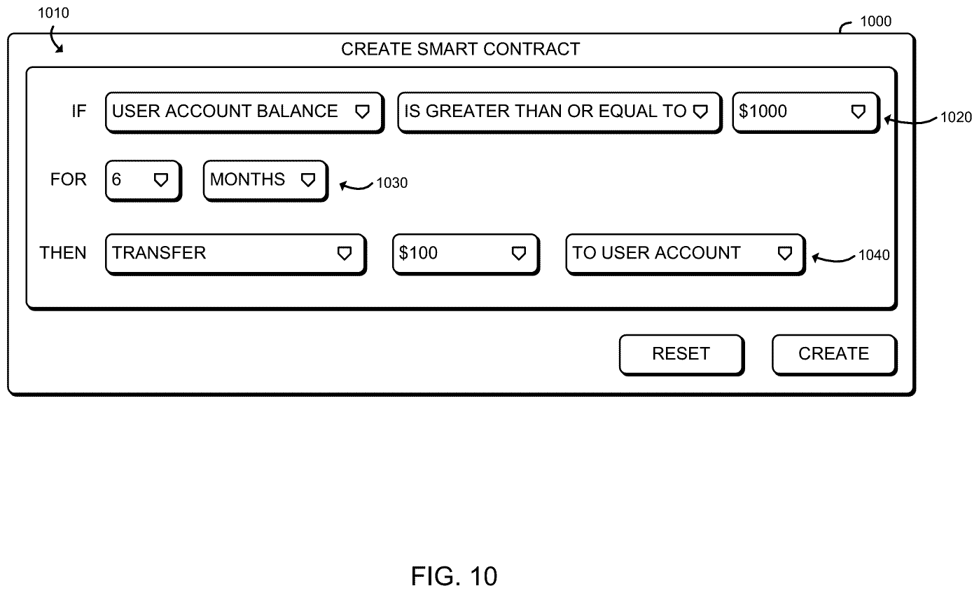

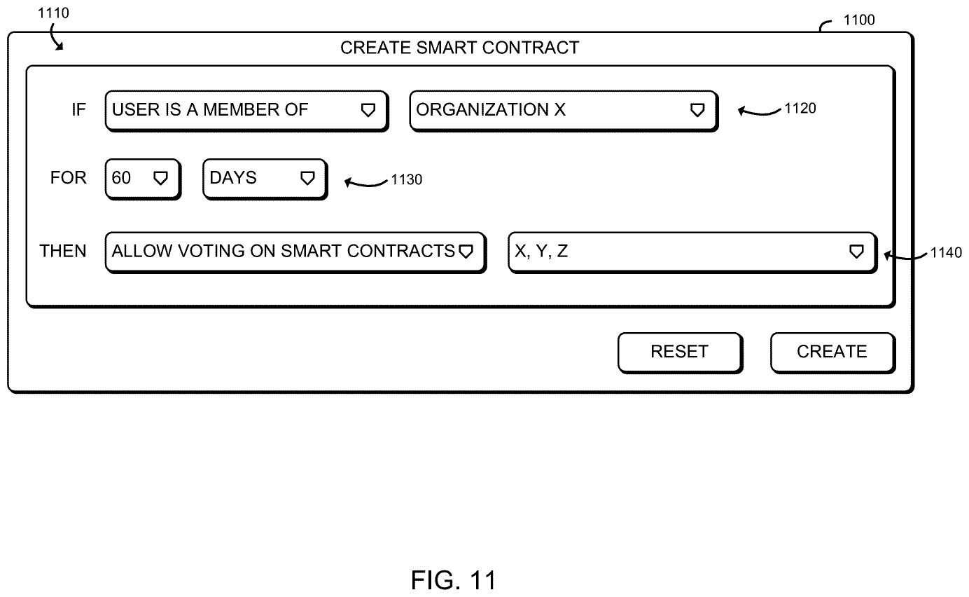

Referring now to FIG. 3, the system 100, and more specifically, the smart contract management compute device 110, in the illustrative embodiment, may perform a method 300 for managing smart contracts. The method 300 begins with block 302 in which the smart contract management compute device 110 determines whether to enable management of smart contracts. In doing so, the smart contract management compute device 110 may determine to enable management of smart contracts in response to a determination that a configuration setting (e.g., in memory 214 or in storage 222) indicates to enable management of smart contracts, in response to receiving a request (e.g., from another compute device 112, 114) to enable management of smart contracts, and/or based on other factors. Regardless, in response to a determination to enable management of smart contracts, the method 300 advances to block 304 in which the smart contract management compute device 110 may obtain a smart contract (e.g., a data set indicative of a smart contract). The smart contract management compute device 110 may obtain the smart contract from another compute device communicatively connected to the smart contract management compute device 110. For example, a client compute device 150, 152 may send a data set indicative of a smart contract (e.g., defined by one or more users 160, 162 through a web-based application, a client-side application, etc.) to the smart contract management compute device 110 (e.g., through an application programming interface (API)). Alternatively, a third party compute device 130 may send data indicative of a smart contract to the smart contract management compute device 110. In some embodiments, a compute device 130, 150, 152 may submit data indicative of smart contract to an intermediary compute device, such as the event stream compute device 112, which may add the smart contract to a corresponding event stream subscribed to by the smart contract management compute device 110. Referring briefly to FIGS. 10 and 11, example embodiments of user interfaces 1000, 1100 that the system 100 may provide may enable no-code or low-code creation of smart contracts. For example, a set of user interface elements 1010, 1110 (e.g., list boxes, text fields, combinations thereof (e.g., combination boxes)) may enable a user to define a set of conditions 1020, 1120 to be satisfied, a time period 1030, 1130 over which the conditions must be satisfied, and one or more actions 1040, 1140 to be performed in response to satisfaction of the conditions. The user interface elements 1010, 1110 may, in some embodiments, progressively appear within the corresponding user interface 1000, 1100 as the user selects values in preceding user interface elements (e.g., to enable selection of parameter values appropriate to the smart contract being defined).

As indicated in block 306, the smart contract management compute device 110, in the illustrative embodiment, obtains data indicative of one or more conditions and one or more responsive actions associated with the smart contract. The condition(s) and responsive action(s) may, in some embodiments, be defined as properties of an object (e.g., a JavaScript Object Notation (JSON) object) representing the smart contract. In the illustrative embodiment, a condition represents a goal or threshold to be satisfied and the responsive action is an action to be executed (e.g., triggered) in response to the condition being satisfied. As indicated in block 308, the smart contract management compute device 110 may obtain a smart contract associated with a decentralized autonomous organization (DAO) of which one or more of the users 160, 162 may be members. In doing so, and as indicated in block 310, the smart contract management compute device 110 may obtain a smart contract indicative of one or more conditions for membership in the DOA. Alternatively, the smart contract management compute device 110 may obtain a smart contract indicative of one or more decisions to be voted on by the DOA, as indicated in block 312. For example, and as indicated in block 314, the smart contract management compute device 110 may obtain a smart contract indicative of a proposed transfer of funds (e.g., from a financial account of the DOA to a financial account of another entity). As another example, and as indicated in block 316, the smart contract management compute device 110 may obtain a smart contract indicative of a proposed change in smart contract logic (e.g., to change the number of votes associated with a governance token, to change whether a decision requires a majority vote, a unanimous vote, or other condition to be met).

In some embodiments, in obtaining a smart contract, the smart contract management compute device 110 obtains a smart contract indicative of a financial agreement among multiple parties (e.g., a financial agreement not related to a DOA), as indicated in block 318. For example, and as indicated in block 320, the smart contract may be indicative of a financial reward for maintaining a target account balance for a defined time period (e.g., a $100 reward for maintaining an account balance of at least $1,000 in a savings account for six months). As another example, the smart contract may be indicative of target number of payments to complete a purchase (e.g., a layaway contract), as indicated in block 322.

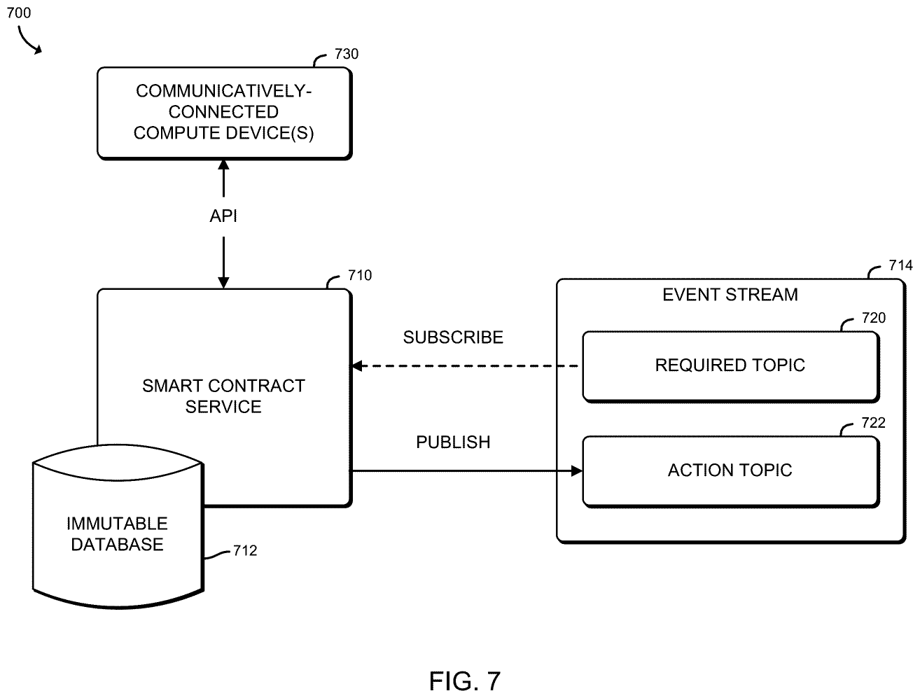

In block 324, the smart contract management compute device 110, in the illustrative embodiment, analyzes the smart contract to identify required topics to subscribe to in an event stream. In doing so, the smart contract management compute device 110 may identify required topics based on parties to the smart contract (e.g., by parsing a property of the smart contract that identifies the parties), as indicated in block 326. The smart contract management compute device 110 may identify one or more required topics based on condition(s) associated with the smart contract (e.g., by parsing a property of the smart contract that identifies the condition(s) to be satisfied), as indicated in block 328. For example, the smart contract may identify, as required topic(s), a party's (e.g., user's 150, 152) account balance, length of account time, value of payment(s) made by a party (e.g., user 160, 162), number of payments made by the party (e.g., user 160, 162), votes cast by a party (e.g., user 160, 162), governance token(s) associated with the party (e.g., user 160, 162), or other topics. In block 330, the smart contract management compute device 110 subscribes to the identified topics (e.g., by submitting a corresponding request to the event stream compute device 114). Referring briefly to the diagram 700 of FIG. 7, a smart contract service executed by the smart contract management compute device 110 subscribes to one or more required topics 720 (e.g., identified by the smart contract management compute device 110 in block 324 of the method 300) in the event stream 714 by sending a corresponding request to the event stream compute device 114 of FIG. 1. As further indicated by the diagram, other communicatively-connected compute devices 730 (e.g., the third party compute device 130, the client compute devices 150, 152, etc.) may communicate with the smart contract service 710 executed by the smart contract management compute device 110 via an application programming interface (API).

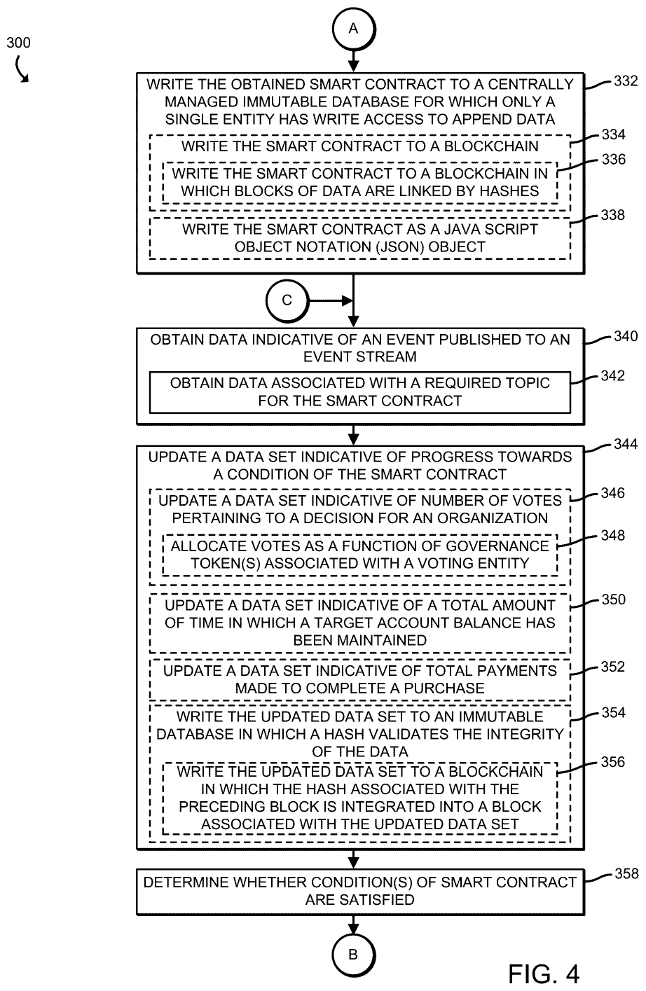

Subsequently, the method 300 advances to block 332 of FIG. 4, in which the smart contract management compute device 110 writes the obtained smart contract to a centrally managed immutable database (e.g., the immutable database 712 of FIG. 7), as indicated in block 332. In the illustrative embodiment, the database (e.g., the database 712) is immutable at least because data may only be added to the database, and may not be deleted or overwritten. Further, in the illustrative embodiment, the database is configured to permit (e.g., due to configuration settings defining access rights) only a single entity (i.e., the entity operating the smart contract management compute device 110 and the immutable database management compute device 112) to write to the database. The database, in the illustrative embodiment, is a blockchain, as indicated in block 334. Further, and as indicated in block 336, the blockchain contains blocks of data that are linked by hashes.

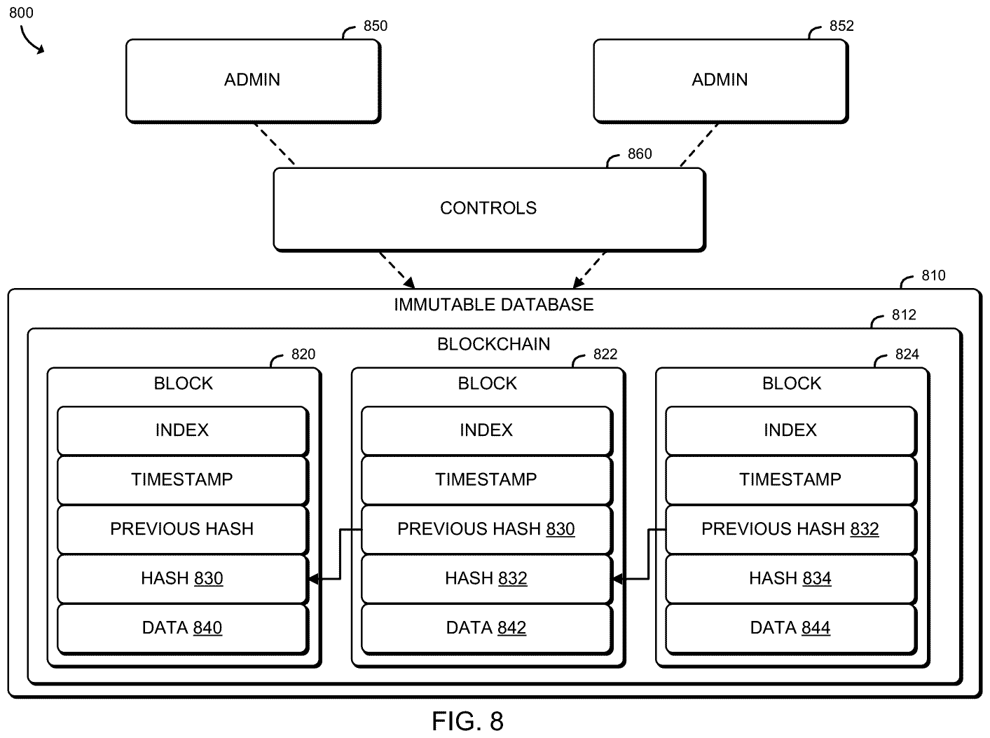

Referring briefly to the diagram 800 of FIG. 8, an embodiment of the database 810 includes a blockchain 812 with multiple blocks 820, 822, 824 in a sequence (e.g., a chain). The blocks are linked together by hashes. Each hash is a data set (e.g., a fixed-length data set) produced by executing a corresponding cryptographic algorithm (e.g., SHA-256, MD5, etc.) on an input data set (e.g., the data 840, 842, 844). For example, block 820 includes a hash 830 produced by executing a cryptographic algorithm, such as SHA-256, on the data 840 (e.g., data representing a smart contract). The block 820 also includes the hash of the previous block (not shown) in the blockchain 812. Likewise, the subsequent block 822 is linked to block 820 because the block 822 includes the hash 830 in addition to a hash 832 produced by executing the cryptographic algorithm on the data 842 (e.g., data indicative of a second smart contract). Additionally, the next block 824 is linked to block 822 due to the inclusion of the hash 832 from the block 822 in the block 824. Like the other blocks, the block 824 contains a hash 834 of the data 844 (e.g., an update to a property, such as a condition, of the smart contract from block 820). A subsequent block (not shown) will include the hash 834, thereby linking that block to the block 824. Insertion of a block between two existing blocks (e.g., blocks 822, 824) is not permitted, as doing so would break the links formed by the hashes (e.g., hash 832). Furthermore, modification or deletion of data in an existing block is not permitted, as doing would cause the hash (which is present in the block to be edited and at least the next block in the chain) to no longer match the data. The database 810 is accessed (e.g., written to) through a layer of controls 860 (e.g., a set of data access permissions, a set of rules by which requests are to be formatted, etc.) managed by the immutable database management compute device 112. As stated above, in the illustrative embodiment, only a single entity (e.g., compute devices associated with administrators 850, 852 of the entity that operates the smart contract management compute device 110 and the immutable database management compute device 112) may write to the immutable database 810.

Referring back to FIG. 4, the smart contract management compute device 110 may write the smart contract (e.g., to the immutable database) as a JSON (JavaScript Object Notation) object. In other embodiments, the smart contract may be defined in another format (e.g., Extensible Markup Language (XML) or other data interchange format), as indicated in block 338. As indicated in block 340, the smart contract management compute device 110 obtains data indicative of an event published to an event stream (e.g., the event stream 714 of FIG. 7). In doing so, and as indicated in block 342, the smart contract management compute device 110 obtains data associated with a required topic for the smart contract (e.g., a topic identified in block 324 of FIG. 3, such as a party to the smart contract, an update pertaining to a condition to be satisfied in the smart contract, etc.). Additionally, and as indicated in block 344, the smart contract management compute device 110 updates a data set indicative of progress towards a condition of the smart contract. In doing so, the smart contract management compute device 110 may update a data set indicative of a number of votes that have been cast pertaining to a decision for an organization (e.g., a DOA), as indicated in block 346. In doing so, the smart contract management compute device 110 may allocate votes as a function of governance tokens associated with a voting entity, as indicated in block 348. For example, if an entity that voted (e.g., according to an update from the event stream) has two governance tokens and each governance token is worth two votes, then the smart contract management compute device 110 may determine that the total number of votes cast by that entity is four.

In some embodiments, the smart contract management compute device 110 may update a data set that is indicative of a total amount of time in which a target account balance has been maintained, as indicated in block 350. For example, a party to a smart contract may have maintained an account balance of at least $1,000 for three months under a smart contract that has a condition under which the party must maintain an account balance at or above $1,000 for six months to receive a reward (e.g., a funds transfer from a bank at which the account is held) of $100. The smart contract management compute device 110 in some embodiments may update a data set indicative of total payments that have been made to complete a purchase (e.g., of an item on layaway), as indicated in block 352. In the illustrative embodiment, the smart contract management compute device 110 writes the updated data set to an immutable database in which a hash value validates the integrity of the data (e.g., a hash produced from executing a cryptographic algorithm, such as SHA-256 or MD5, on the data set), as indicated in block 354. In doing so, and as indicated in block 356, the smart contract management compute device 110 may write the updated data set to a blockchain in which the hash associated with preceding block is integrated into a block associated with the updated data set (e.g., block 824 of FIG. 8, which includes the hash 832 from the previous block 822). In block 358, the smart contract management compute device 110 determines whether the condition(s) of the smart contract have been satisfied (e.g., whether sufficient votes have been cast, whether an account balance has been maintained for a sufficient time period, whether the total number of payments made to purchase an item are sufficient).

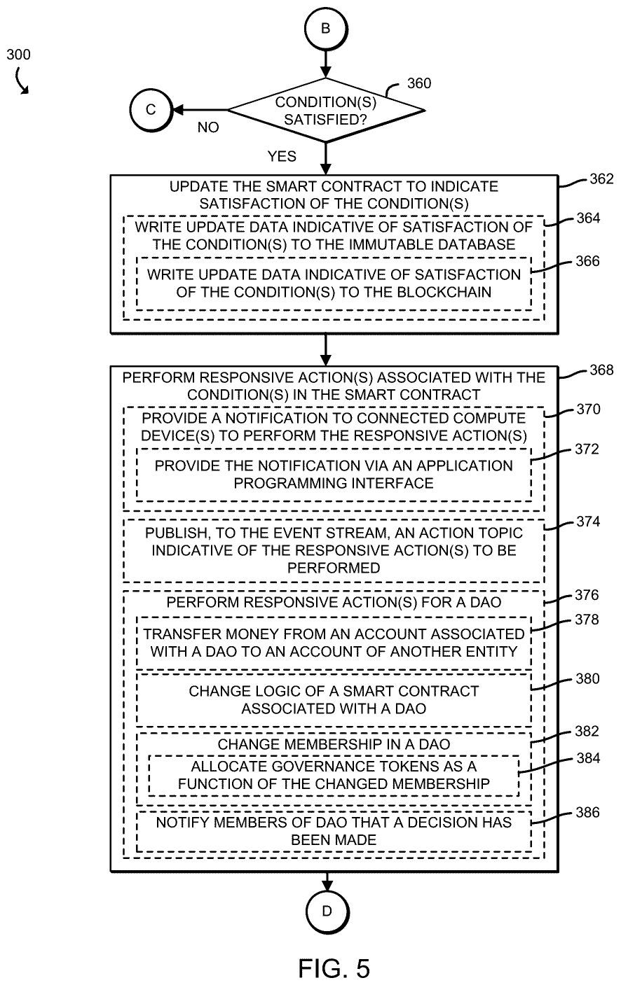

Afterwards, the method 300 advances to block 360 of FIG. 5, in which the smart contract management compute device 110 determines the subsequent course of action based on whether the condition(s) of the smart contract have been satisfied. In response to a determination that the condition(s) have not been satisfied, the method 300 loops back to block 340 of FIG. 4, in which the smart contract management compute device 110 may obtain additional data indicative of an event published to an event stream (e.g., indicating further progress towards satisfaction of a condition in a smart contract). Otherwise, the method 300 advances to block 362 in which the smart contract management compute device 110 updates the smart contract to indicate satisfaction of the condition(s). In doing so, and as indicated in block 364, the smart contract management compute device 110 may write update data indicative of satisfaction of the condition(s) to the immutable database (e.g., the immutable database 712, 810). In the illustrative embodiment, the smart contract management compute device 110 does so by writing the update data indicative of satisfaction of the condition(s) to a blockchain (e.g., the blockchain 812), as indicated in block 366.

Subsequently, in block 368, the smart contract management compute device 110 performs one or more responsive actions associated with the satisfied condition(s) of the smart contract. In doing so, the smart contract management compute device 110 may produce a notification to one or more connected compute devices (e.g., one or more of compute devices 114, 130, 150, 152, 730) to perform the responsive action(s) (e.g., the responsive action(s) defined in the smart contract), as indicated in block 370. In doing so, and as represented in block 372, the smart contract analysis compute device may provide the notification via an application programming interface (API). In some embodiments, the smart contract management compute device 110 may publish, to the event stream (e.g., the event stream 714), an action topic (e.g., an action topic 722 in FIG. 7) indicative of the responsive action(s) to be performed, as indicated in block 374. In some embodiments, the smart contract management compute device 110 may perform the responsive action(s) for a distributed autonomous organization (DAO) (e.g., if the smart contract pertains to a DAO), as indicated in block 376. For example, and as indicated in block 378, the smart contract management compute device 110 may transfer money from an account associated with a DAO to an account of another entity (e.g., in response to a determination that sufficient votes were cast in support of the transfer of funds). As indicated in block 380, the smart contract management compute device 110 may change the logic of a smart contract associated with a DAO (e.g., if sufficient votes were cast in support of the logic change). For example, the smart contract management compute device 110 may change one or more condition(s) that must be satisfied to trigger execution of a corresponding responsive action. The smart contract management compute device 110 may write the updated condition or other change to the smart contract logic to the immutable database 712, 810 (e.g., as a block in the blockchain 812).

In some embodiments, the smart contract management compute device 110 may change the membership in a DOA (e.g., if an entity has satisfied the condition(s) for becoming a member of the DAO), as indicated in block 382. In doing so, the smart contract management compute device 110 may allocate governance tokens as a function of the changed membership (e.g., by assigning governance tokens to the new member in accordance with a standard amount of governance tokens to be assigned to a new member, in accordance with an amount of money contributed to by the new member to an account associated with the DAO, etc.), as indicated in block 384. As indicated in block 386, the smart contract management compute device 110 may also notify members of the DAO that a decision has been made. For example, the smart contract management compute device 110 may send a notification to the corresponding client compute devices 150, 152 of the members 160, 162 indicating that funds have been transferred, that a condition of a smart contract associated with the DAO has been changed, that a new member has been added, or that a member has been removed. The smart contract management compute device 110 may, in some embodiments, send the notification through a corresponding API.

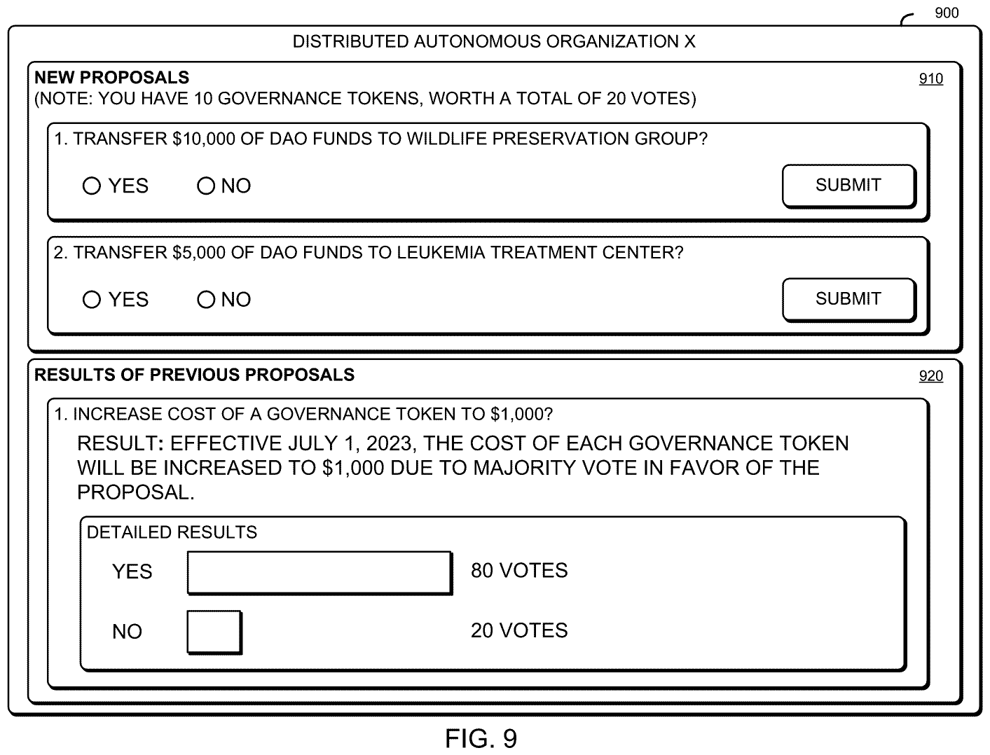

Referring briefly to FIG. 9, an embodiment of a user interface 900 that may be presented by the system 100 to a user 160, 162 (e.g., each a member of a distributed autonomous organization) is illustrated. The user interface 900 includes a section 910 with proposals to be voted on by the user and a section 920 summarizing an older proposal that was voted on and for which a decision was made according to the logic of an underlying smart contract for the DAO (i.e., to change the cost of a governance token in response to a majority vote in favor of doing so). In addition to or as an alternative to providing information through a user interface, such as the user interface 900 of FIG. 9, in some embodiments, the smart contract management compute device 110 may send information (e.g., notifications) through another channel, such as a short message service (SMS) message, an email, a phone call (e.g., through an interactive voice response (IVR) system), or publication to a stream (e.g., the event stream 714, a really simple syndication (RSS) feed, etc.).

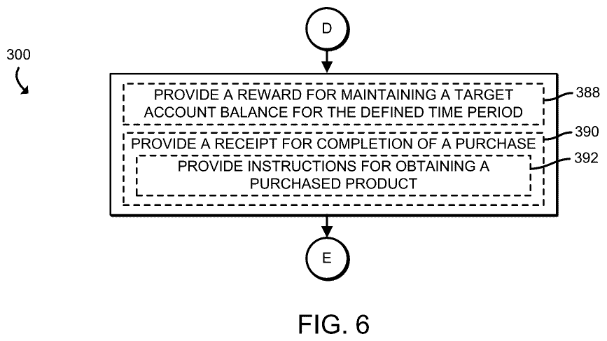

Referring now to FIG. 6, in some embodiments, in performing a responsive action, the smart contract management compute device 110 may provide a reward for maintaining a target account balance for a defined time period (e.g., at least $1,000 for six months), as indicated in block 388. In some embodiments, the smart contract management compute device 110 may provide a receipt for completion of a purchase (e.g., after a purchase price has been completely paid over a series of installments under a layaway agreement defined in a smart contract), as indicated in block 390. Further, in such embodiments, the smart contract management compute device 110 may provide instructions (e.g., to the party who completed the purchase under the layaway agreement) for obtaining the purchased product (e.g., instructions on where to pick up the purchased product from a store or warehouse), as represented in block 392. Subsequently, the method 300 loops back to block 302 in which the smart contract management compute device 110 determines whether to continue to manage smart contracts.

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### Examples

Illustrative examples of the technologies disclosed herein are provided below. An embodiment of the technologies may include any one or more, and any combination of, the examples described below.

Example 1 includes a compute device comprising circuitry configured to obtain a smart contract indicative of a condition and a responsive action to be performed upon satisfaction of the condition; write the smart contract to a centrally managed immutable database; obtain, from an event stream, data indicative of an event published to the event stream; determine, as a function of the event published to the event stream and the smart contract, whether the condition has been satisfied; and perform, in response to a determination that the condition has been satisfied, the responsive action.

Example 2 includes the subject matter of Example 1, and wherein to write the smart contract to a centrally managed immutable database comprises to write the smart contract to a centrally managed blockchain in which blocks of data are linked with corresponding hashes.

Example 3 includes the subject matter of any of Examples 1 and 2, and wherein the circuitry is further configured to analyze the smart contract to identify a topic; and subscribe to the identified topic in the event stream to obtain the data indicative of the event published to the event stream.

Example 4 includes the subject matter of any of Examples 1-3, and wherein to obtain a smart contract comprises to obtain a smart contract associated with a decentralized autonomous organization.

Example 5 includes the subject matter of any of Examples 1-4, and wherein to obtain a smart contract associated with a decentralized autonomous organization comprises to obtain a smart contract indicative of a condition for membership in the decentralized autonomous organization.

Example 6 includes the subject matter of any of Examples 1-5, and wherein to obtain a smart contract associated with a decentralized autonomous organization comprises to obtain a smart contract indicative of a decision to be voted on by the decentralized autonomous organization.

Example 7 includes the subject matter of any of Examples 1-6, and wherein to obtain a smart contract indicative of a decision to be voted on comprises to obtain a smart contract indicative of a proposed transfer of funds from the decentralized autonomous organization.

Example 8 includes the subject matter of any of Examples 1-7, and wherein to obtain a smart contract indicative of a decision to be voted on comprises to obtain a smart contract indicative of a proposed change in smart contract logic.

Example 9 includes the subject matter of any of Examples 1-8, and wherein to obtain a smart contract comprises to obtain a smart contract indicative of a financial agreement between multiple parties.

Example 10 includes the subject matter of any of Examples 1-9, and wherein to obtain a smart contract indicative of a financial agreement between multiple parties comprises to obtain a smart contract indicative of a financial reward for maintaining a target account balance for a defined time period.

Example 11 includes the subject matter of any of Examples 1-10, and wherein to obtain a smart contract indicative of a financial agreement between multiple parties comprises to obtain a smart contract indicative of target number of payments to complete a purchase.

Example 12 includes the subject matter of any of Examples 1-11, and wherein the circuitry is further configured to update, in response to obtaining the data indicative of the event, a data set indicative of progress towards the condition indicated in the smart contract.

Example 13 includes the subject matter of any of Examples 1-12, and wherein to update the data set indicative of progress towards the condition comprises to update a data set indicative of a number of votes pertaining to a decision for a decentralized autonomous organization.

Example 14 includes the subject matter of any of Examples 1-13, and wherein the circuitry is further configured to allocate the votes as a function of a number of governance tokens associated with a voting entity.

Example 15 includes the subject matter of any of Examples 1-14, and wherein to update the data set indicative of progress towards the condition comprises to update a data set indicative of a total amount of time in which a target account balance has been maintained.

Example 16 includes the subject matter of any of Examples 1-15, and wherein to update the data set indicative of progress towards the condition comprises to update a data set indicative of total payments made to complete a purchase.

Example 17 includes the subject matter of any of Examples 1-16, and wherein the circuitry is further configured to write the updated data set to the centrally managed immutable database.

Example 18 includes the subject matter of any of Examples 1-17, and wherein the circuitry is further configured to write, to the centrally managed immutable database, update data indicative of satisfaction of the condition associated with the smart contract.

Example 19 includes the subject matter of any of Examples 1-18, and wherein the circuitry is further configured to provide a notification to a connected compute device to perform the responsive action.

Example 20 includes the subject matter of any of Examples 1-19, and wherein the circuitry is further configured to publish, to the event stream, an action topic indicative of the responsive action to be performed.

Example 21 includes the subject matter of any of Examples 1-20, and wherein to perform the responsive action comprises to transfer money from an account associated with a decentralized autonomous organization to an account associated with another entity.

Example 22 includes the subject matter of any of Examples 1-21, and wherein to perform the responsive action comprises to change logic of a smart contract associated with a decentralized autonomous organization.

Example 23 includes the subject matter of any of Examples 1-22, and wherein to perform the responsive action comprises to change a membership of a decentralized autonomous organization.

Example 24 includes the subject matter of any of Examples 1-23, and wherein the circuitry is further configured to allocate one or more governance tokens as a function of the changed membership.

Example 25 includes the subject matter of any of Examples 1-24, and wherein to perform the responsive action comprises to provide a reward for maintaining a target account balance for a defined time period.

Example 26 includes the subject matter of any of Examples 1-25, and wherein to perform the responsive action comprises to provide a receipt for completion of a purchase that was made through multiple payments.

Example 27 includes the subject matter of any of Examples 1-26, and wherein the circuitry is further configured to provide instructions for obtaining a product associated with the completed purchase.

Example 28 includes a method comprising obtaining, by a compute device, a smart contract indicative of a condition and a responsive action to be performed upon satisfaction of the condition; writing, by the compute device, the smart contract to a centrally managed immutable database; obtaining, by the compute device and from an event stream, data indicative of an event published to the event stream; determining, by the compute device, as a function of the event published to the event stream and the smart contract, whether the condition has been satisfied; and performing, by the compute device and in response to a determination that the condition has been satisfied, the responsive action.

Example 29 includes the subject matter of Example 28, and wherein writing the smart contract to a centrally managed immutable database comprises writing the smart contract to a centrally managed blockchain in which blocks of data are linked with corresponding hashes.

Example 30 includes the subject matter of any of Examples 28 and 29, and further including analyzing, by the compute device, the smart contract to identify a topic; and subscribing, by the compute device, to the identified topic in the event stream to obtain the data indicative of the event published to the event stream.

Example 31 includes the subject matter of any of Examples 28-30, and wherein obtaining a smart contract comprises obtaining a smart contract associated with a decentralized autonomous organization.

Example 32 includes the subject matter of any of Examples 28-31, and wherein obtaining a smart contract associated with a decentralized autonomous organization comprises obtaining a smart contract indicative of a condition for membership in the decentralized autonomous organization.

Example 33 includes the subject matter of any of Examples 28-32, and wherein obtaining a smart contract associated with a decentralized autonomous organization comprises obtaining a smart contract indicative of a decision to be voted on by the decentralized autonomous organization.

Example 34 includes the subject matter of any of Examples 28-33, and wherein obtaining a smart contract indicative of a decision to be voted on comprises obtaining a smart contract indicative of a proposed transfer of funds from the decentralized autonomous organization.

Example 35 includes the subject matter of any of Examples 28-34, and wherein obtaining a smart contract indicative of a decision to be voted on comprises obtaining a smart contract indicative of a proposed change in smart contract logic.

Example 36 includes the subject matter of any of Examples 28-35, and wherein obtaining a smart contract comprises obtaining a smart contract indicative of a financial agreement between multiple parties.

Example 37 includes the subject matter of any of Examples 28-36, and wherein obtaining a smart contract indicative of a financial agreement between multiple parties comprises obtaining a smart contract indicative of a financial reward for maintaining a target account balance for a defined time period.

Example 38 includes the subject matter of any of Examples 28-37, and wherein obtaining a smart contract indicative of a financial agreement between multiple parties comprises obtaining a smart contract indicative of target number of payments to complete a purchase.

Example 39 includes the subject matter of any of Examples 28-38, and further including updating, by the compute device and in response to obtaining the data indicative of the event, a data set indicative of progress towards the condition indicated in the smart contract.

Example 40 includes the subject matter of any of Examples 28-39, and wherein updating the data set indicative of progress towards the condition comprises updating a data set indicative of a number of votes pertaining to a decision for a decentralized autonomous organization.

Example 41 includes the subject matter of any of Examples 28-40, and further including allocating, by the compute device, the votes as a function of a number of governance tokens associated with a voting entity.

Example 42 includes the subject matter of any of Examples 28-41, and wherein updating the data set indicative of progress towards the condition comprises updating a data set indicative of a total amount of time in which a target account balance has been maintained.

Example 43 includes the subject matter of any of Examples 28-42, and wherein updating the data set indicative of progress towards the condition comprises updating a data set indicative of total payments made to complete a purchase.

Example 44 includes the subject matter of any of Examples 28-43, and further including writing, by the compute device, the updated data set to the centrally managed immutable database.

Example 45 includes the subject matter of any of Examples 28-44, and further including writing, by the compute device and to the centrally managed immutable database, update data indicative of satisfaction of the condition associated with the smart contract.

Example 46 includes the subject matter of any of Examples 28-45, and further including providing, by the compute device, a notification to a connected compute device to perform the responsive action.

Example 47 includes the subject matter of any of Examples 28-46, and further including publishing, by the compute device and to the event stream, an action topic indicative of the responsive action to be performed.

Example 48 includes the subject matter of any of Examples 28-47, and wherein performing the responsive action comprises transferring money from an account associated with a decentralized autonomous organization to an account associated with another entity.

Example 49 includes the subject matter of any of Examples 28-48, and wherein performing the responsive action comprises changing logic of a smart contract associated with a decentralized autonomous organization.

Example 50 includes the subject matter of any of Examples 28-49, and wherein performing the responsive action comprises changing a membership of a decentralized autonomous organization.

Example 51 includes the subject matter of any of Examples 28-50, and further including allocating, by the compute device, one or more governance tokens as a function of the changed membership.

Example 52 includes the subject matter of any of Examples 28-51, and wherein performing the responsive action comprises providing a reward for maintaining a target account balance for a defined time period.

Example 53 includes the subject matter of any of Examples 28-52, and wherein performing the responsive action comprises providing a receipt for completion of a purchase that was made through multiple payments.

Example 54 includes the subject matter of any of Examples 28-53, and further including providing, by the compute device, instructions for obtaining a product associated with the completed purchase.

Example 55 includes one or more machine-readable storage media comprising a plurality of instructions stored thereon that, in response to being executed, cause a compute device to obtain a smart contract indicative of a condition and a responsive action to be performed upon satisfaction of the condition; write the smart contract to a centrally managed immutable database; obtain, from an event stream, data indicative of an event published to the event stream; determine, as a function of the event published to the event stream and the smart contract, whether the condition has been satisfied; and perform, in response to a determination that the condition has been satisfied, the responsive action.

Example 56 includes the subject matter of Example 55, and wherein to write the smart contract to a centrally managed immutable database comprises to write the smart contract to a centrally managed blockchain in which blocks of data are linked with corresponding hashes.

Example 57 includes the subject matter of any of Examples 55 and 56, and wherein the one or more instructions further cause the compute device to analyze the smart contract to identify a topic; and subscribe to the identified topic in the event stream to obtain the data indicative of the event published to the event stream.

Example 58 includes the subject matter of any of Examples 55-57, and wherein to obtain a smart contract comprises to obtain a smart contract associated with a decentralized autonomous organization.

Example 59 includes the subject matter of any of Examples 55-58, and wherein to obtain a smart contract associated with a decentralized autonomous organization comprises to obtain a smart contract indicative of a condition for membership in the decentralized autonomous organization.

Example 60 includes the subject matter of any of Examples 55-59, and wherein to obtain a smart contract associated with a decentralized autonomous organization comprises to obtain a smart contract indicative of a decision to be voted on by the decentralized autonomous organization.

Example 61 includes the subject matter of any of Examples 55-60, and wherein to obtain a smart contract indicative of a decision to be voted on comprises to obtain a smart contract indicative of a proposed transfer of funds from the decentralized autonomous organization.

Example 62 includes the subject matter of any of Examples 55-61, and wherein to obtain a smart contract indicative of a decision to be voted on comprises to obtain a smart contract indicative of a proposed change in smart contract logic.

Example 63 includes the subject matter of any of Examples 55-62, and wherein to obtain a smart contract comprises to obtain a smart contract indicative of a financial agreement between multiple parties.

Example 64 includes the subject matter of any of Examples 55-63, and wherein to obtain a smart contract indicative of a financial agreement between multiple parties comprises to obtain a smart contract indicative of a financial reward for maintaining a target account balance for a defined time period.

Example 65 includes the subject matter of any of Examples 55-64, and wherein to obtain a smart contract indicative of a financial agreement between multiple parties comprises to obtain a smart contract indicative of target number of payments to complete a purchase.

Example 66 includes the subject matter of any of Examples 55-65, and wherein the one or more instructions further cause the compute device to update, in response to obtaining the data indicative of the event, a data set indicative of progress towards the condition indicated in the smart contract.

Example 67 includes the subject matter of any of Examples 55-66, and wherein to update the data set indicative of progress towards the condition comprises to update a data set indicative of a number of votes pertaining to a decision for a decentralized autonomous organization.

Example 68 includes the subject matter of any of Examples 55-67, and wherein the one or more instructions further cause the compute device to allocate the votes as a function of a number of governance tokens associated with a voting entity.

Example 69 includes the subject matter of any of Examples 55-68, and wherein to update the data set indicative of progress towards the condition comprises to update a data set indicative of a total amount of time in which a target account balance has been maintained.

Example 70 includes the subject matter of any of Examples 55-69, and wherein to update the data set indicative of progress towards the condition comprises to update a data set indicative of total payments made to complete a purchase.

Example 71 includes the subject matter of any of Examples 55-70, and wherein the one or more instructions further cause the compute device to write the updated data set to the centrally managed immutable database.

Example 72 includes the subject matter of any of Examples 55-71, and wherein the one or more instructions further cause the compute device to write, to the centrally managed immutable database, update data indicative of satisfaction of the condition associated with the smart contract.

Example 73 includes the subject matter of any of Examples 55-72, and wherein the one or more instructions further cause the compute device to provide a notification to a connected compute device to perform the responsive action.

Example 74 includes the subject matter of any of Examples 55-73, and wherein the one or more instructions further cause the compute device to publish, to the event stream, an action topic indicative of the responsive action to be performed.

Example 75 includes the subject matter of any of Examples 55-74, and wherein to perform the responsive action comprises to transfer money from an account associated with a decentralized autonomous organization to an account associated with another entity.

Example 76 includes the subject matter of any of Examples 55-75, and wherein to perform the responsive action comprises to change logic of a smart contract associated with a decentralized autonomous organization.

Example 77 includes the subject matter of any of Examples 55-76, and wherein to perform the responsive action comprises to change a membership of a decentralized autonomous organization.

Example 78 includes the subject matter of any of Examples 55-77, and wherein the one or more instructions further cause the compute device to allocate one or more governance tokens as a function of the changed membership.

Example 79 includes the subject matter of any of Examples 55-78, and wherein to perform the responsive action comprises to provide a reward for maintaining a target account balance for a defined time period.

Example 80 includes the subject matter of any of Examples 55-79, and wherein to perform the responsive action comprises to provide a receipt for completion of a purchase that was made through multiple payments.

Example 81 includes the subject matter of any of Examples 55-80, and wherein the one or more instructions further cause the compute device to provide instructions for obtaining a product associated with the completed purchase.

1. A compute device comprising:
circuitry configured to:
obtain a smart contract indicative of a condition and a responsive action to be performed upon satisfaction of the condition;
write the smart contract to a centrally managed immutable database;
obtain, from an event stream, data indicative of an event published to the event stream;
determine, as a function of the event published to the event stream and the smart contract, whether the condition has been satisfied; and
perform, in response to a determination that the condition has been satisfied, the responsive action.

2. The compute device of claim 1, wherein to write the smart contract to a centrally managed immutable database comprises to write the smart contract to a centrally managed blockchain in which blocks of data are linked with corresponding hashes.

3. The compute device of claim 1, wherein the circuitry is further configured to:
analyze the smart contract to identify a topic; and
subscribe to the identified topic in the event stream to obtain the data indicative of the event published to the event stream.

4. The compute device of claim 1, wherein to obtain a smart contract comprises to obtain a smart contract associated with a decentralized autonomous organization.

5. The compute device of claim 4, wherein to obtain a smart contract associated with a decentralized autonomous organization comprises to obtain a smart contract indicative of a condition for membership in the decentralized autonomous organization.

6. The compute device of claim 4, wherein to obtain a smart contract associated with a decentralized autonomous organization comprises to obtain a smart contract indicative of a decision to be voted on by the decentralized autonomous organization.

7. The compute device of claim 6, wherein to obtain a smart contract indicative of a decision to be voted on comprises to obtain a smart contract indicative of a proposed transfer of funds from the decentralized autonomous organization.

8. The compute device of claim 6, wherein to obtain a smart contract indicative of a decision to be voted on comprises to obtain a smart contract indicative of a proposed change in smart contract logic.

9. The compute device of claim 1, wherein to obtain a smart contract comprises to obtain a smart contract indicative of a financial agreement between multiple parties.

10. The compute device of claim 9, wherein to obtain a smart contract indicative of a financial agreement between multiple parties comprises to obtain a smart contract indicative of a financial reward for maintaining a target account balance for a defined time period.

11. The compute device of claim 9, wherein to obtain a smart contract indicative of a financial agreement between multiple parties comprises to obtain a smart contract indicative of target number of payments to complete a purchase.

12. The compute device of claim 1, wherein the circuitry is further configured to update, in response to obtaining the data indicative of the event, a data set indicative of progress towards the condition indicated in the smart contract.

13. The compute device of claim 12, wherein to update the data set indicative of progress towards the condition comprises to update a data set indicative of a number of votes pertaining to a decision for a decentralized autonomous organization.

14. The compute device of claim 13, wherein the circuitry is further configured to allocate the votes as a function of a number of governance tokens associated with a voting entity.

15. The compute device of claim 12, wherein to update the data set indicative of progress towards the condition comprises to update a data set indicative of a total amount of time in which a target account balance has been maintained.

16. The compute device of claim 12, wherein to update the data set indicative of progress towards the condition comprises to update a data set indicative of total payments made to complete a purchase.

17. The compute device of claim 12, wherein the circuitry is further configured to write the updated data set to the centrally managed immutable database.

18. The compute device of claim 1, wherein the circuitry is further configured to write, to the centrally managed immutable database, update data indicative of satisfaction of the condition associated with the smart contract and wherein to perform the responsive action comprises to transfer money from an account associated with a decentralized autonomous organization to an account associated with another entity, change logic of a smart contract associated with the decentralized autonomous organization, change a membership of the decentralized autonomous organization, provide a reward for maintaining a target account balance for a defined time period, or provide a receipt for completion of a purchase that was made through multiple payments.

19. A method comprising:
obtaining, by a compute device, a smart contract indicative of a condition and a responsive action to be performed upon satisfaction of the condition;
writing, by the compute device, the smart contract to a centrally managed immutable database;
obtaining, by the compute device and from an event stream, data indicative of an event published to the event stream;
determining, by the compute device, as a function of the event published to the event stream and the smart contract, whether the condition has been satisfied; and
performing, by the compute device and in response to a determination that the condition has been satisfied, the responsive action.

20. One or more machine-readable storage media comprising a plurality of instructions stored thereon that, in response to being executed, cause a compute device to:
obtain a smart contract indicative of a condition and a responsive action to be performed upon satisfaction of the condition;
write the smart contract to a centrally managed immutable database;
obtain, from an event stream, data indicative of an event published to the event stream;
determine, as a function of the event published to the event stream and the smart contract, whether the condition has been satisfied; and
perform, in response to a determination that the condition has been satisfied, the responsive action.
